(19) United States
(12) Patent Application Publication
(10) Pub. No.: US 2026/0121361 A1
(43) Pub. Date: Apr. 30, 2026

(54) Novel multi-faceted stereoscopic power strip

(71) Applicant: Honglin Electric Power Technology (Thailand) Co., Ltd., Rayong (TH)

(72) Inventors: Shengchao HU, Rayong (TH); Xiongbing LIU, Rayong (TH); Li YU, Rayong (TH)

(73) Assignee: Honglin Electric Power Technology (Thailand) Co., Ltd., Rayong (TH)

(21) Appl. No.: 18/930,097

(22) Filed: Oct. 29, 2024

(51) Int. Cl. H01R 25/00; H01R 13/512; H01R 13/70; H01R 13/72

(52) U.S. Cl. CPC H01R 25/003; H01R 13/512; H01R 13/70; H01R 13/72

(57) ABSTRACT

The present invention relates to the field of electric energy transmission technology, in particular to a novel multi-faceted stereoscopic power strip, comprising a rear cover and a front panel, the front panel and the rear cover are matched and connected by bolts, on the front panel are provided with round ports, switch ports, USB ports and type-c ports; a circuit board is installed in the rear cover and the front panel, and the circuit board is connected with a power supply wire extending outside the front panel. The novel multi-faceted stereoscopic power strip provided by the present invention can not only provide more jacks, but also adopt jacks inclined to both sides, thereby avoiding interferences caused by inserting multiple large plugs into the jacks, and meanwhile, it is inconvenient to wind and reel the power supply wire, and the operation is simple and practical.

### TECHNICAL FIELD

The present invention relates to the field of electric energy transmission technology, in particular to a novel multi-faceted stereoscopic power strip.

### BACKGROUND TECHNOLOGY

In production and daily life, in order to conveniently use electrical appliances, it is often necessary to use power strips. The use of power strips can increase number of jacks, thereby enabling the connection of more electrical devices. Therefore, the use of power strips is extremely widespread in both production and daily life.

However, existing power strips with increased number of jacks still have some issues. Firstly, current power strips are generally flat with two or three jacks. When large transformer plugs are inserted into the power strips, interferences often occur between adjacent jacks. Secondly, existing power strips are not convenient for winding and unwinding power lines. Therefore, a novel multi-faceted stereoscopic power strip is needed to address these problems.

### SUMMARY OF THE INVENTION

The purpose of embodiments of the present invention is to provide a novel multi-faceted stereoscopic power strip, aiming to solve following problems: when large plugs are inserted into jacks of existing power strips, interferes occur between adjacent jacks and it is inconvenient to wind up power supply wires.

Embodiments of the present invention are implemented as follows: a novel multi-faceted stereoscopic power strip comprises a rear cover and a front panel, wherein the front panel and the rear cover are matched and connected by bolts, on the front panel are provided with round ports, switch ports, USB ports and type-c ports; and a circuit board is installed in the rear cover and the front panel, and the circuit board is connected with a power supply wire extending outside the front panel.

Preferably, the round ports on the front panel are provided with power supply jacks connected to the circuit board, multiple power supply jacks are arranged for being inserted by plugs, the switch ports on the front panel are provided with switches connected to the circuit board, switches are used to control on and off of circuits of the circuit board and the power supply wire, the USB ports on the front panel are provided with USB sockets connected to the circuit board, and the type-c ports on the front panel are provided with type-c sockets connected to the circuit board.

Preferably, at both end portions of the rear cover are fixedly arranged wire-wrap boards and the power supply wire is wound via the wire-wraps boards.

Preferably, the front panel is designed to be inclined from middle portions to both side portions to avoid interferences caused by inserting multiple large plugs into the power supply jacks.

Preferably, the rear cover and the front panel are made of metal materials.

The novel multi-faceted stereoscopic power strip provided by the present invention can not only provide more jacks, but also adopt jacks inclined to both sides, thereby avoiding interferences caused by inserting multiple large plugs into the jacks, and meanwhile, it is inconvenient to wind and reel the power supply wire, and the operation is simple and practical.

### BRIEF DESCRIPTION OF THE DRAWINGS

FIG. 1 is a schematic diagram of a novel multi-faceted stereoscopic power strip.

FIG. 2 is a schematic diagram of a circuit board of the novel multi-faceted stereoscopic power strip.

The markups in the drawings are as follows:
1—rear cover;
2—front panel;
3—circuit board;
4—power supply wire;
5—power supply jack;
6—switch;
7—USB plug;
8—type-c plug; and
9—wire-wrap board.

### SPECIFIC EMBODIMENTS

In order to make the purpose, technical solutions and advantages of the present invention more clear, the present invention is further described in detail in combination with accompanying drawings and embodiments. It should be understood that the specific embodiments described here are only used to explain the present invention and do not limit the present invention.

The specific implementation of the present invention is described in detail in combination with specific embodiments.

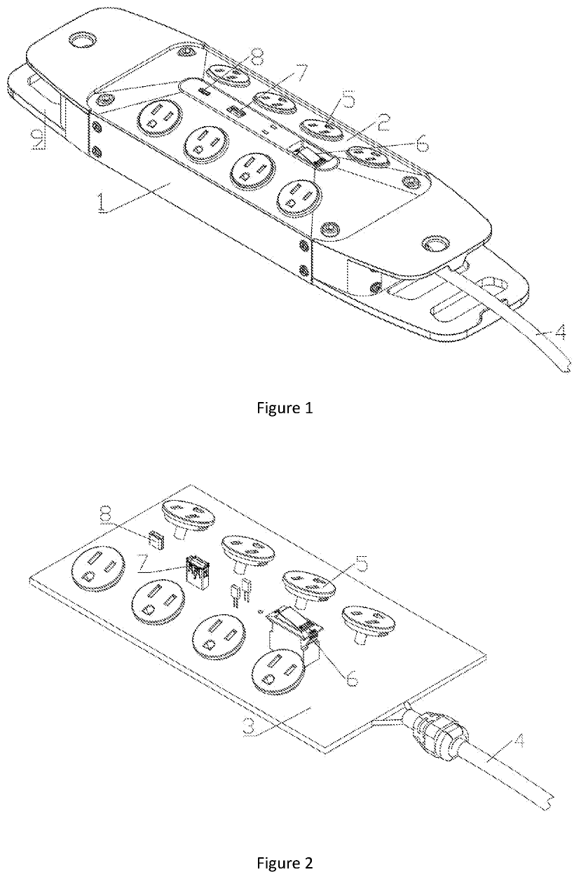

Please refer to FIGS. 1 and 2, and embodiment of the present invention provides a novel multi-faceted stereoscopic power strip, and the novel multi-faceted stereoscopic power strip comprises:
a rear cover 1 and a front panel 2, wherein the front panel 2 and the rear cover 1 are matched and connected by bolts, on the front panel 2 are provided with round ports, switch ports, USB ports and type-c ports; and a circuit board 3 is installed in the rear cover 1 and the front panel 2, and the circuit board 3 is connected with a power supply wire 4 extending outside the front panel 2.

As shown in FIGS. 1 and 2, in a preferable embodiment of the present invention, the round ports on the front panel 2 are provided with power supply jacks 5 connected to the circuit board 3, multiple power supply jacks 5 are arranged for being inserted by plugs, the switch ports on the front panel 2 are provided with switches 6 connected to the circuit board 3, switches 6 are used to control on and off of circuits of the circuit board 3 and the power supply wire 4, the USB ports on the front panel 2 are provided with USB sockets 7 connected to the circuit board 3, and the type-c ports on the front panel 2 are provided with type-c sockets 8 connected to the circuit board 3.

When the novel multi-faceted stereoscopic power strip is used, first, a plug on the power supple wire 4 is connected to an alternative current power socket to power the circuit board 3, then power plugs are inserted into power supply jacks 5, USB plugs are inserted into the USB sockets 7, and type-c plugs are inserted into the type-c sockets correspondingly, after then, the switches 6 are pressed to connect the power supply wire 4 with the circuit board 3, so as to supply power to various electrical devices.

As shown in FIG. 1, in a preferable embodiment of the present invention, at both end portions of the rear cover 1 are fixedly arranged wire-wrap boards 9 and the power supply wire 4 is wound via the wire-wraps boards 9.

The wire-wrap boards 9 are designed to wind the power supply line 4, and can be used as handles to facilitate moving the novel multi-faceted stereoscopic power strip.

As shown in FIG. 1, in a preferable embodiment of the present invention, the front panel 2 is designed to be inclined from middle portions to both side portions to avoid interferences caused by inserting multiple large plugs into the power supply jacks.

As shown in FIG. 1, in a preferable embodiment of the present invention, the rear cover 1 and the front panel 2 are made of metal materials.

The rear cover 1 and the front panel 2 are designed with metal materials to make the novel multi-faceted stereoscopic power strip resistant to falling and extrusion, thereby extending the service life of the novel multi-faceted stereoscopic power strip.

The above are only preferable embodiments of the present invention and are not intended to limit the present invention, and any modification, equivalent replacement, improvement, etc. made within the spirit and principles of the present invention shall be included in the scope of protection of the present invention.

1. A novel multi-faceted stereoscopic power strip, comprising a rear cover and a front panel, wherein the front panel and the rear cover are matched and connected by bolts, on the front panel are provided with round ports, switch ports, USB ports and type-c ports; and
a circuit board is installed in the rear cover and the front panel, and the circuit board is connected with a power supply wire extending outside the front panel.

2. The novel multi-faceted stereoscopic power strip according to claim 1, wherein the round ports on the front panel are provided with power supply jacks connected to the circuit board, multiple power supply jacks are arranged for being inserted by plugs, the switch ports on the front panel are provided with switches connected to the circuit board, switches are used to control on and off of circuits of the circuit board and the power supply wire, the USB ports on the front panel are provided with USB sockets connected to the circuit board, and the type-c ports on the front panel are provided with type-c sockets connected to the circuit board.

3. The novel multi-faceted stereoscopic power strip according to claim 1, wherein at both end portions of the rear cover are fixedly arranged wire-wrap boards and the power supply wire is wound via the wire-wraps boards.

4. The novel multi-faceted stereoscopic power strip according to claim 2, wherein the front panel is designed to be inclined from middle portions to both side portions to avoid interferences caused by inserting multiple large plugs into the power supply jacks.

5. The novel multi-faceted stereoscopic power strip according to claim 1, wherein the rear cover and the front panel are made of metal materials.
